(19) United States
(12) Patent Application Publication
(10) Pub. No.: US 2011/0138958 A1
(43) Pub. Date: Jun. 16, 2011

(54) SHIFT FORK WITH TWO SHIFT JAWS FOR A GEARBOX

(75) Inventor: Eckhard KIRCHNER, Ginsheim (DE)

(73) Assignee: GM GLOBAL TECHNOLOGY OPERATIONS LLC, Detroit, MI (US)

(21) Appl. No.: 12/964,665

(22) Filed: Dec. 9, 2010

(30) Foreign Application Priority Data
Dec. 10, 2009 (GB) 0921622.7

(51) Int. Cl. F16H 61/26; F16H 61/18; G05G 5/02

(52) U.S. Cl. 74/473.25

(57) ABSTRACT

A shift fork is provided for a gearbox of a vehicle, preferably a motorized vehicle. The shift fork includes, but is not limited to a first shift jaw and a second shift jaw. The first shift jaw and the second shift jaw include, but are not limited to a first shifting recess and a second shifting recess, respectively. The first shifting recess and the second shifting recess include, but are not limited to a first stop portion for blocking the movement of the first shift jaw in a first direction and a second stop portion for blocking a movement of the second shift jaw in a second direction.

### CROSS-REFERENCE TO RELATED APPLICATION

This application claims priority to British Patent Application No. 0921622.7, filed Dec. 10, 2009, which is incorporated herein by reference in its entirety.

### TECHNICAL FIELD

The application relates to an actuation mechanism for actuation of a reverse gear and a forward gear of a manual transmission for a passenger car.

### BACKGROUND

It is desirable to provide mechanic and/or mechatronic means to ensure that a gear, especially the reverse gear, cannot be engaged at the wrong time. A gear shifting arrangement with an H-pattern is designed in such a way that a gear cannot be engaged unless the driver selects the corresponding shift gate. Therefore a certain security is provided to place the reverse gear on a separate shift gate. In an H shift pattern, the selection of a shift gate is achieved by moving a gear lever along a selector gate that is oriented perpendicular to the shift gates.

In addition, several mechanisms are known to prevent an engagement of a reverse gear at a wrong time. One known mechanism to avoid engagement of a reverse gear by providing a pulling ring at a gear knob. The reverse gear cannot be engaged unless the driver pulls the pulling ring.

Furthermore it is known from DE 10 2006 007 248 A1 to provide a blocking cylinder with a special form such that the blocking cylinder forms an obstacle for engaging the reverse gear. The driver can, however, overcome the obstacle by using sufficient force.

In view of the foregoing, it is at least one object to provide an improved shift fork which is capable of actuating a forward gear as well as actuating a reverse gear. In addition, other objects, desirable features and characteristics will become apparent from the subsequent summary and detailed description, and the appended claims, taken in conjunction with the accompanying drawings and this background.

### SUMMARY

The improved shift fork according to an embodiment is suitable for providing an arrangement using different shift gates for the forward gear and the reverse gear. The shift fork is preferably provided for a gearbox of a motorized vehicle. The shift fork comprises a first shift jaw and a second shift jaw. The first shift jaw and the second shift jaw comprise a first shifting recess and a second shifting recess respectively. The first shifting recess and the second shifting recess comprise, respectively, a first stop portion for blocking the movement of the first shift jaw in a first direction and a second stop portion for blocking a movement of the second shift jaw in a second direction.

The second direction is opposite to the first direction. The first stop portion and the second stop portion are situated at different sides of a neutral plane which is perpendicular to a direction of movement of the shift fork. The direction of movement of the shift fork is defined by the movement of the shift fork between two engagement positions in which a gear of the gearbox is engaged. The blocking of the movement of a shift jaw is achieved by mechanical contact of the blocking portion with a blocking cylinder.

In the context of this application, the shifting recess will also be referred to as a “hollow profile” and the stop portion will also be referred to as a “blocking portion”.

The location of the stop portions at different sides of the neutral plane has the advantage of blocking engagement of one of two gears when the gear is not selected, provided that respective gearwheels of the two gears are located on opposite sides of a double sided synchronizer.

A shift fork is also provided in which the first stop portion and the second stop portion are formed as circular sections. The circular sections have a radius which is slightly larger than a radius of the blocking cylinder.

Furthermore, a shift fork is provided in which, in addition, the first shifting recess comprises a first opening for engagement with a shift finger and the second shifting recess comprises a second opening for engagement with the shift finger. The first opening and the second opening are preferably aligned such that the first opening and the second opening are arranged along an axis that is perpendicular to the direction of movement of the shift fork.

Through the alignment of the openings along an axis, a shift finger of a shift shaft can engage with the openings by up and down movement of the shift shaft into a corresponding select position for selecting a gear. The gearbox is preferably built such that a selection of an adjacent shift gate moves the shift shaft up or down by one selection step, which is also called a “unit of select travel”.

The first opening and the second opening may be arranged opposite to an end of the first stop portion and to an end of the second stop portion. “End” refers to one of two ends of the portion along a direction of movement of the shift fork and “opposite” refers to opposite sides relative to an axis of a shift shaft.

In addition, a gearbox is provided with a switch fork, a drive train with the gearbox, and a motor car, for example a passenger car or a truck, with the drive train.

### BRIEF DESCRIPTION OF THE DRAWINGS

The present invention will hereinafter be described in conjunction with the following drawing figures, wherein like numerals denote like elements, and

FIG. 1 illustrates a partial view of a shift fork according to a first embodiment;

FIG. 2 illustrates a first shift jaw of the shift fork of FIG. 1;

FIG. 3 illustrates a second shift jaw of the shift fork of FIG. 1;

FIG. 4 illustrates a view of a first shift shaft arrangement for use with the shift fork of FIG. 1;

FIG. 5 illustrates a view of a second shift shaft arrangement for use with the shift fork of FIG. 1;

FIG. 6 illustrates a first cross section through the shift fork of FIG. 1 and a blocking cylinder for a first position of the blocking cylinder;

FIG. 7 illustrates a second cross section through the shift fork of FIG. 1 and a blocking cylinder for a first position of the blocking cylinder;

FIG. 8 illustrates a first cross section through the shift fork of FIG. 1 and a blocking cylinder for a second position of the blocking cylinder;

FIG. 9 illustrates a second cross section through the shift fork of FIG. 1 and a blocking cylinder for a second position of the blocking cylinder;

FIG. 10 illustrates a shift fork according to a second embodiment;

FIG. 11 illustrates a first cross section through the shift fork of FIG. 10 and a blocking cylinder;

FIG. 12 illustrates a second cross section through the shift fork of FIG. 1 and a blocking cylinder;

FIG. 13 illustrates a shift pattern for use with the shift fork according to FIG. 1 or FIG. 10; and

FIG. 14 illustrates a gearbox layout for use with the shift fork according to FIG. 1 or FIG. 10.

### DETAILED DESCRIPTION

The following detailed description is merely exemplary in nature and is not intended to limit application and uses. Furthermore, there is no intention to be bound by any theory presented in the preceding background or summary or the following detailed description.

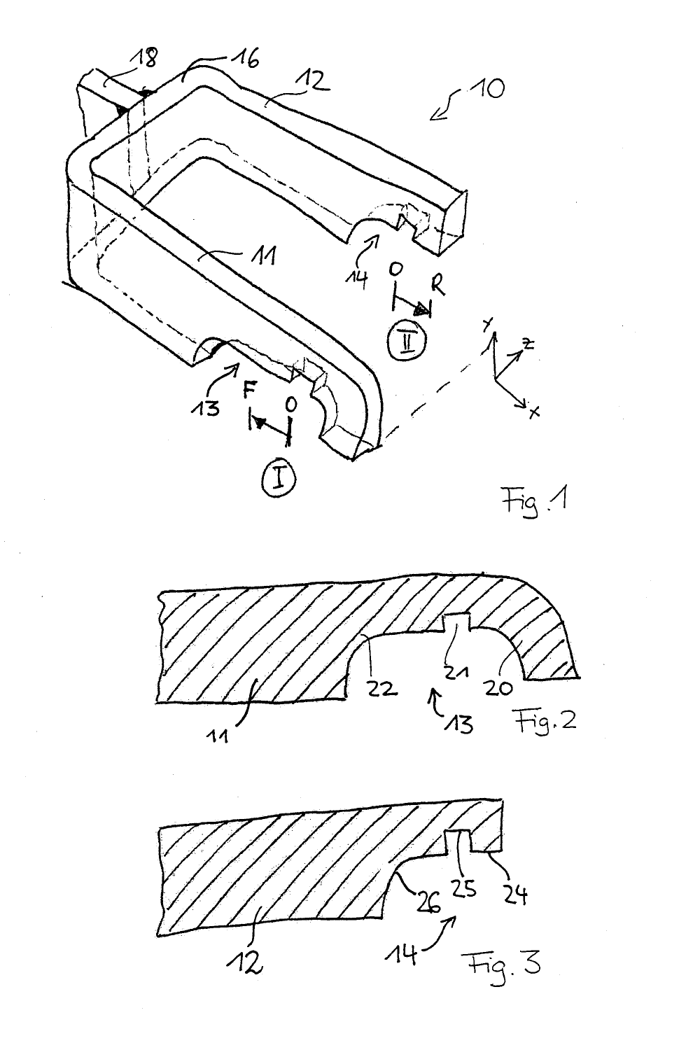

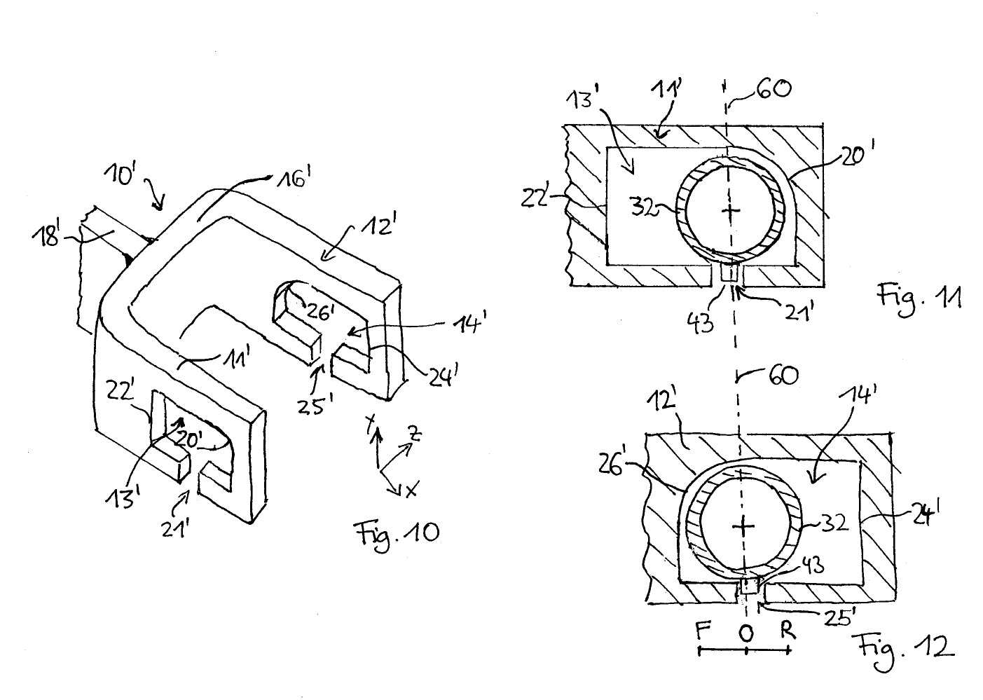

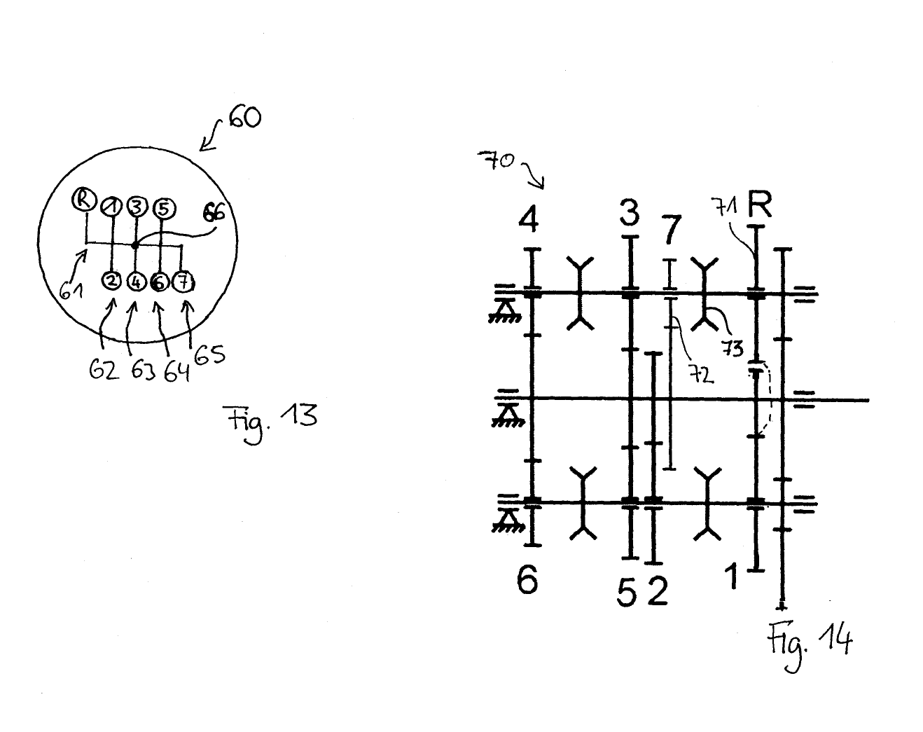

FIG. 1 shows a first embodiment of a shift fork 10. Only a jaw portion of the shift fork 10 is shown in FIG. 10. The remaining parts of the shift fork 10 are realized in a known way, for example as shown in FIG. 5. The shift fork 10 comprises a first gearshift jaw 11 and a second gearshift jaw 12. The first gearshift jaw 11 is formed as a plane portion of the shift fork 10 and comprises a first hollow profile 13. The hollow profile 13 is situated at the bottom of an end portion of the first gearshift jaw 11 and is shown in more detail in FIG. 2. Likewise, the second gearshift jaw 12 is formed as a plane portion of the shift fork 10 and comprises a second hollow profile 14. The second hollow profile 14 is situated at the bottom of an end portion of the second gearshift jaw 12.

The first gearshift jaw 11 and the second gearshift jaw 12 are oriented substantially parallel to each other and are also oriented substantially parallel to a direction of motion of the shift fork 10. A joining portion 16 of the shift fork 10 that is oriented at a substantial right angle to the first gearshift jaw 11 and the second gearshift jaw 12 holds the gearshift jaws 11 and 12 at a selection distance. The first gearshift jaw 11, the joining portion 16 and the second gearshift jaw 12 form a U shape. The arms of the U shape have different lengths. However, the arms may also have equal lengths. A first end of a connecting portion 18 of the shift fork 10 is attached to the joining portion 16 at a right angle to the joining portion 16. A second end of the connection portion 18, which is not shown in FIG. 1, is attached to a linear ball bearing, which can be best seen in FIG. 5.

The shift fork 10 is movable in an x-direction parallel to the gearshift jaws 11, 12. A neutral position of the shift fork 10 is indicated by a 0, a forward gear position of the shift fork 10 is indicated by an F and a reverse gear position of the shift fork is indicated by an R.

FIG. 2 shows a side view of the first gearshift jaw 11 of the shift fork 10 of FIG. 1. The hollow profile 13 of the first gearshift jaw 11 comprises an outer circular portion 20, a rectangular recess 21 for a shift finger and an inner portion 22. The outer circular portion 20 has the form of a circle section of almost 90 degrees. The radius of the circular portion 20 is slightly larger than the radius of a blocking cylinder. The shift finger and the blocking cylinder are not shown in FIG. 2 but can be seen in FIG. 4 and FIG. 5. The inner portion 22 comprises a straight portion and a rounded portion.

FIG. 2 shows a side view of the second gearshift jaw 12 of the shift fork 10 of FIG. 1. The hollow profile 14 of the second gearshift jaw 12 comprises a straight outer portion 24, a rectangular recess 25 for a shift finger and a circular inner portion 26. The circular inner portion 26 has the form of a circle section of almost 90 degrees and the radius of the circular inner portion 26 is slightly larger than the radius of the aforementioned blocking cylinder.

FIG. 4 shows a first shift shaft arrangement 28 for use with a shift fork 10. The shift shaft arrangement 28 comprises, from top to bottom, a gear cap 30, a shift shaft 32 with blocking cylinders 33, 34, a cap 35. The gear cap 30 comprises an opening 36 for a select cable. The select cable is connected to the select lever 37. The select lever fits into a guiding groove which is not shown in FIG. 4. The guiding groove is similar to the guiding groove 53 of FIG. 5.

The shift shaft 32 of FIG. 4 comprises, from top to bottom, a top portion 38, a first blocking cylinder 33 with a first opening 39 and a first shift finger 40, a middle portion 41, a second blocking cylinder 34 with a second opening 42 and a second shift finger 43, and a bottom portion 44 which is supported in the cap 35 The cap 35 comprises a shaft support cylinder 46 which is mounted to a base plate 47 via a socket. The socket 47 is mounted to a gearbox casing which is not shown in FIG. 4.

The shift shaft 32 is movable upwards and downwards for selecting a shift gate in an H shifting pattern. The vertical movement of the shift shaft 32 is indicated by a double arrow 48. Furthermore, the shift shaft 32 is rotatable around its axis for selecting or deselecting one of two gears of a shift gate in an H shifting pattern. The rotation of the shift shaft 32 is indicated by a double arrow 49.

In FIG. 4, parts above the upper part 38 of the shift shaft 32 are not shown. They comprise a shift mass and a shift cable which is attached to it, for rotating the shift shaft 32. A shift mass and a shift cable are shown in FIG. 5. Furthermore, the upper part 38 is supported in a bearing which is also not shown in FIG. 4.

FIG. 5 shows a second shift shaft arrangement 28′ which is similar to the first shift shaft arrangement 28. For reasons of simplicity only the parts which are not shown in FIG. 4 or are different from FIG. 4 are explained. A shift mass 50 is mounted on top of a shift shaft 32′ and a shift cable 51 is fixed to the shift mass 50. A gear cap is omitted from FIG. 5 such that the upper part of the shift shaft 32′ and the upper part of a first blocking cylinder 33′ can be seen. At the upper part of the shift shaft 32′, a guiding groove 53 is provided. The guiding groove 53 matches with a select lever to which a select cable is attached. The select lever that is movable in a vertical direction is not shown in FIG. 5.

FIG. 5 furthermore shows a conventional shift fork 56. The shift shaft 32′ is in a vertical position such that a gearshift jaw 57 of the conventional shift fork is at the same height of the opening 39′ of the blocking cylinder 33′ and fits into the first opening 39′. The conventional shift fork 56 is supported on an axis via a linear ball bearing 58. The axis, which is not shown in FIG. 5, is oriented parallel to a gear shaft of the gearbox that carries the gears which are engaged by movement of the shift fork 10. A fork 59 of the conventional shift fork is provided next to the linear ball bearing 58. The dimension of the fork 59 are such that a shift collar, which is not shown in FIG. 5, fits into the fork 59 of the conventional shift fork.

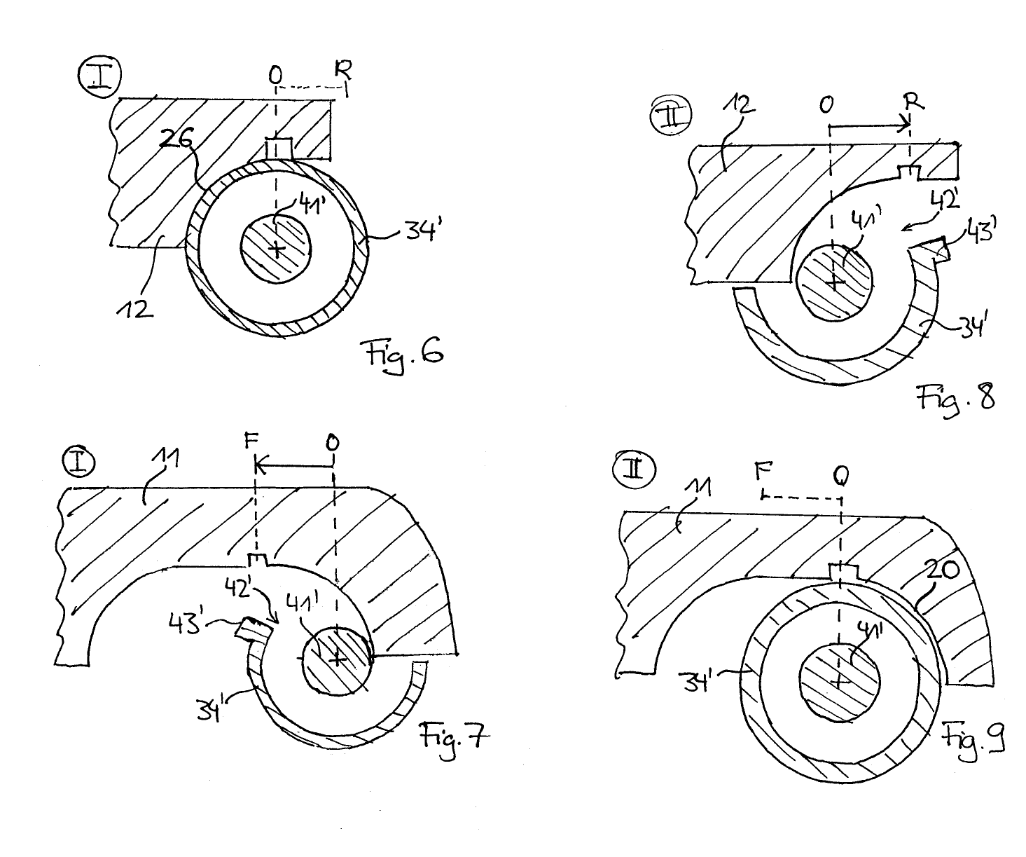

The function of a shift fork according to the application is now explained in FIGS. 6 to 9. FIG. 6 and FIG. 7 show cross sections through the blocking cylinder 34′ and the gearshift jaws 11, 12, respectively, whereby the shift shaft 32′ is in a lower position I. FIG. 8 and FIG. 9 show cross sections through the blocking cylinder 34′ and the gearshift jaws 11, 12, respectively, whereby the shift shaft 32′ is in an upper position II.

In the following, the shift gate of the forward gear which is actuated by the shift fork 10 shall be called “high shift gate” and the shift gate of the reverse gear which is actuated by the shift fork 10 shall be called “reverse shift gate.” An example for a layout of shift gates according to an H-pattern is shown in FIG. 13. The shift fork 10 is arranged between a specific forward gear and a reverse gear. When a driver selects the high shift gate, the shift shaft 32′ moves to the lower position I. If the driver, on the other hand, selects the reverse shift gate, the shift shaft moves to the upper position II. If the driver selects a shift gate which is different from the high shift gate or the reverse shift gate, the shift shaft moves to one of several further positions. In the further positions both the forward selection and the backward selection of the shift fork 10 is blocked, which is equivalent to a situation as shown in FIG. 6 and FIG. 9.

FIG. 6 illustrates a blocking of the movement of the shift fork 10 into the reverse gear position when the shift shaft 32′ is engaged in the lower position I. When the shift shaft 32′ is engaged in the lower position I, the opening 42′ of the blocking cylinder 34′ is not in the plane of the gearshift jaw 12. If a force is applied to the gearshift jaw 12 to move it in the reverse gear position, the circular inner portion 26 of the second gearshift jaw 12 is pressed against the outer side of the blocking cylinder 34′ and further movement of the second gearshift jaw 12 is blocked by the blocking cylinder 34′.

FIG. 7 illustrates a movement of the shift fork 10 into the forward gear position when the shift shaft 32′ is engaged in the lower position I. When the shift shaft 32′ is engaged in the lower position I, the opening 42′ and the shift finger 43′ which is attached to the blocking cylinder 34′ are in the plane of the first gearshift jaw 11. When the driver selects the forward gear of the forward-backward shift gate, a negative torque is applied to the shift shaft 32′ and to the blocking cylinder 43′ that is attached to the shift shaft 32′, the shift finger 43′ pushes the first gearshift jaw 11 to a forward gear position. The position of the opening 42 is arranged such that the opening 42′ releases the first gearshift jaw 11. The first gearshift jaw 11 is not blocked by the outer side of the blocking cylinder 33′ and moves into the forward position.

FIG. 8 illustrates a movement of the shift fork 10 into the reverse gear position when the shift shaft 32′ is engaged in the upper position II. When the shift shaft 32′ is engaged in the upper position II, the opening 42′ and the shift finger 43′ which is attached to the blocking cylinder 34′ are in the plane of the second gearshift jaw 12. When the driver selects the reverse gear of the forward-backward shift gate, a positive torque is applied to the shift shaft 32′ and to the blocking cylinder 43′ that is attached to the shift shaft 32′. The shift finger 43′ pushes the second gearshift jaw 12 to a reverse gear position. The position of the opening 42 is arranged such that the opening 42′ releases the second gearshift jaw 12. The second gearshift jaw 12 is not blocked by the outer side of the blocking cylinder 33′ and moves into the reverse position.

FIG. 9 illustrates a blocking of the movement of the shift fork 10 into the forward gear position when the shift shaft 32′ is engaged in the upper position II. When the shift shaft 32′ is engaged in the upper position II, the opening 42′ of the blocking cylinder 34′ is not in the plane of the gearshift jaw 11. If a force is applied to the first gearshift jaw 11 to move it in the forward gear position, the circular portion 20 of the first gearshift jaw 11 is pressed against the outer side of the blocking cylinder 34′ and further movement of the first gearshift jaw 11 is blocked by the blocking cylinder 34′.

FIG. 10 shows an alternative embodiment of a shift fork 10′ according to the application. Similar parts have primed reference numbers. The embodiment of FIG. 10 is suitable for an arrangement in which the shift finger of a blocking cylinder is situated on the opposite side of the opening of the blocking cylinder. Such a situation is shown in FIG. 4, in which the opening 42 of blocking cylinder 34 is on the opposite side of the shift finger 43 of blocking cylinder 34. The shift fork 10′ is similar to the shift fork is similar to the shift fork 10 but the hollow profiles 13′ and 14′ in the gearshift jaws 11′ and 12′ are different from the hollow profiles 13 and 14 of the shift fork 10. A dashed line 60 shows the neutral position of the shift fork 10′. The dashed line 60 defines a neutral plane which goes through the axis of the shift shaft 32, is parallel to the axis of the shift shaft 32 and is at a right angle to the shaft which carries the gears that are engaged by actuating the shift fork 10′.

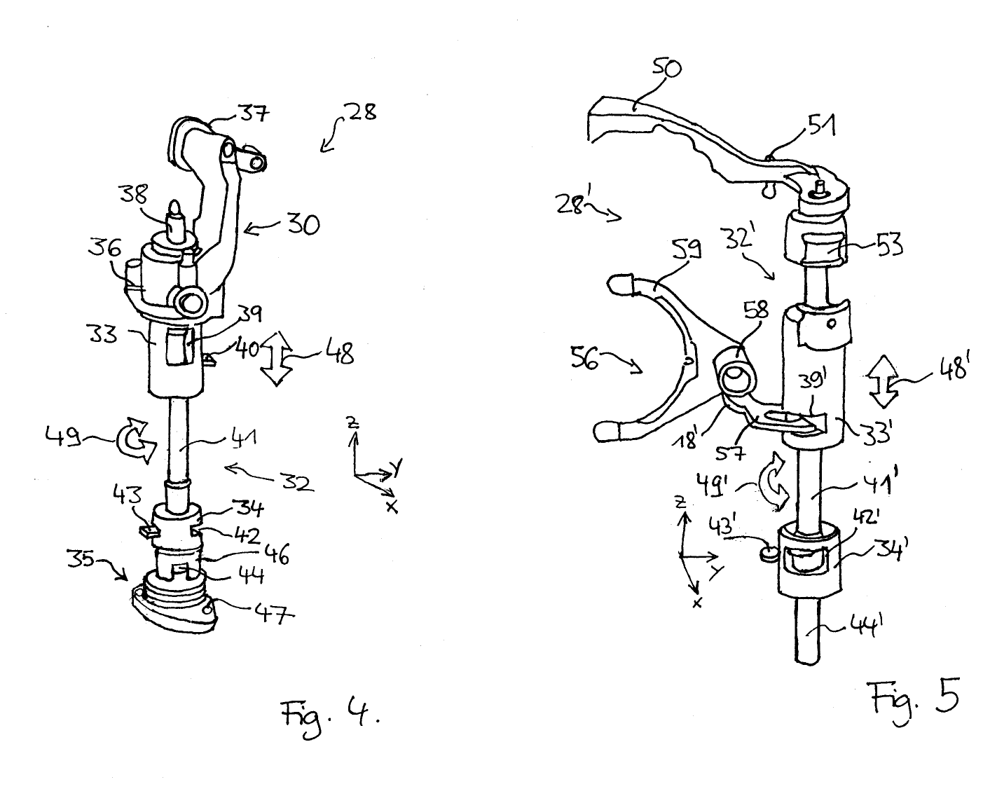

The hollow profile 13′ of the first gearshift jaw 11′ comprises an outer circular portion 20′, an opening 21′ for engagement with a shift finger and an inner portion 22′. Similar to the shift fork 10 of FIG. 1 to FIG. 3, the outer circular portion 20′ is formed as a circular section of almost 90 degrees with a radius that is slightly bigger than the radius of the blocking cylinder 34. Similar to the shift fork 10, the outer circular portion 20′ and the inner portion 22′ of the first gearshift jaw 11′ are situated on different sides of the neutral plane. Different from the shift fork 10, the hollow profile 13′ of the first gearshift jaw 11′ almost encloses the shift shaft 32 except for an opening 21′ that has the same function as the rectangular recess 21 of the previous embodiment.

The hollow profile 14′ of the second gearshift jaw 12′ comprises an inner circular portion 26′, an opening 25′ for engagement with a shift finger and an outer portion 24′. Similar to the shift fork 10 of FIG. 1 to FIG. 3, the inner circular portion 20′ is formed as a circular section of almost 90 degrees with a radius that is slightly bigger than the radius of the blocking cylinder 34. Similar to the shift fork 10, the inner circular portion 26′ and the outer portion 24′ of the second gearshift jaw 12′ are situated on different sides of the neutral plane. Different from the shift fork 10, the hollow profile 14′ of the second gearshift jaw 12′ almost encloses the shift shaft 32 except for an opening 25′ which has the same function as the rectangular recess 25 of the previous embodiment. Similar to the shift fork 10, the inner circular portion 26′ of the second gearshift jaw 12′ and the outer circular portion 20′ of the first gearshift jaw 11′ are on different sides of the neutral plane.

FIG. 13 illustrates a gear shifting arrangement 60 for use with a shift fork according to the embodiments. The shifting pattern 60 comprises from left to right the shift gates 61, 62, 63, 64, 65. A neutral shift point 66 indicates the middle position of the shift knob with respect to the horizontal select movement. The shift gate 61, 62, 63, 64, 65 are spaced at equal distances. The distance between two shift gates corresponds to one unit of select travel of the select cable. In the example of FIG. 13, the reverse gear and the seventh gear is spaced two units of select travel from the neutral point. The movement of the select cable by one unit of select travel translates into the up or downward movement of the shift shaft 32; 32′ by one unit of select travel of the shift shaft 32; 32′.

When providing a shift fork 10; 10′ for actuation of the reverse gear and for actuation of the seventh gear, it is advantageous, although not mandatory, to space the planes of the first gearshift jaw 11; 11′ and of the second gearshift jaw 12; 12′ apart by four units of select travel of the shift shaft 32, 32′. In general, it is advantageous to space apart the planes of the first gearshift jaw 11; 11′ and of the second gearshift jaw 12; 12′ by as many units of select travel of the shift shaft 32; 32′ as there are between the shift gates of the reverse gear and the high gear. Otherwise, a special mechanism would have to be provided to generate the desired relationship between the shifting movement of the driver and the movement of the shift shaft 32, 32′. Moreover, it is preferable place the lower shift jaw below the axis of the linear ball bearing of the shift fork and the upper shift jaw above the axis of the linear ball bearing of the shift fork to provide enough space for the gearwheels.

FIG. 14 shows a stick diagram of a gearbox 70 for use with an H-shifting pattern according to FIG. 13. A gear selection on the shift gates 62, 63, 64 corresponds to a movement of a double sided synchronizer between gearwheels that correspond to the gears of the respective shift gate. In contrast, the tooth gear 71 of the reverse gear and the tooth gear 72 seventh gear are actuated by the same double synchronizer 73 but are on different shift gates 61, 65 in the shifting pattern 60. A shift fork 10; 10′ according to the application is in form fit with the double synchronizer 73. The shift fork 10; 10′ is not shown in the stick diagram of FIG. 14.

A gearbox layout with a shift fork according to an embodiment is provided for fitting an additional high gear into an existing layout of a gearbox, if there is enough space to provide a gearwheel of the additional high gear next to a reverse gear in the existing layout. For example a seventh gear may be fitted in a six gear gearbox. The seven gear gearbox can then be produced with parts of the six gear gearbox, thereby saving production costs. Furthermore the use of a double sided synchronizer with a shift fork according to the application saves space as compared to the use of two separate shift forks. This in turn facilitates the fitting of an additional gear into an existing gearbox layout.

The shift fork according to the embodiments ensures that the reverse gear cannot be engaged when the shift gate of the reverse gear is not selected even though the reverse gear and a forward gear are actuated by the same double sided synchronizer.

The concept of a shift fork with two shift jaws is easy to realize and does not require a special arrangement at the blocking cylinder or the shift shaft, such as for example two concentric shift shafts or the like. By using two shift jaws according to the embodiments, the modification of the shift shaft and the blocking cylinder for adding a high gear that is actuated by the same synchronizer as a reverse gear can be done in a known and proven way. In addition, a standard H-shifting pattern can be maintained in which the gear numbers of the shift gates increase from left to right and the reverse gear is located on a separate shift gate.

The modification of an existing gearbox is especially convenient for an existing arrangement with an even number of gears in which the reverse gear is located on a separate shift track. In this case, the synchronizer of the reverse gear is usually the only one that is available for use by an additional odd high gear. The double usage of a synchronizer, in turn, saves space while minimizing modifications to the existing layout of the gearbox.

The use of a shift fork with two shift jaws according to the embodiments provides the same security against unwanted selection of the high gear or the reverse gear in a gearbox layout where reverse and high gear are actuated with the same synchronizer as with a gearbox layout where reverse and high gear are actuated by different synchronizers. Depending on the placement of the shift shaft, the first gearshift jaw 11; 11′ may also be the upper gearshift jaw and the second gearshift jaw 12; 12′ may also be the lower gearshift jaw. Depending on the placement of the gearwheels and the shift shaft, the placement of the hollow profiles 13; 13′ and the hollow profiles 14; 14′ on the gearshift jaws 11, 12; 11′, 12′ may be swapped. Furthermore, the function of the shift jaws may be swapped, that is the gearshift jaw 11; 11′ may be used to actuate a reverse gear and the second gearshift jaw 12; 12′ may be used to actuate a forward gear.

The joining portion may be shaped in various ways, for example as tapered portion and not in a plate shape and the placement of the gearshift jaws may also be asymmetrical with respect to the connecting portion. Instead of cables, other actuation mechanisms may also be used to move the shift fork and the shift shaft.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shift fork for a gearbox of a motorized vehicle, comprising:
a first shift jaw;
a first shifting recess comprising a first stop portion for blocking a first movement of the first shift jaw in a first direction;
a second shift jaw; and
a second shifting recess comprising a second stop portion for blocking a second movement of the second shift jaw in a second direction.

2. The shift fork according to claim 1, wherein the first stop portion and the second stop portion are formed as circular sections.

3. The shift fork according to claim 1, further comprising:
a first opening for engagement with a shift finger; and
a second opening for engagement with the shift finger.

4. The shift fork according to claim 3, wherein the first opening and the second opening are arranged along an axis that is substantially perpendicular to a third direction of movement of the shift fork.

5. The shift fork according to claim 3, wherein the first opening is adjacent to the first stop portion and the second opening is adjacent to the second stop portion.

6. The shift fork according to claim 3, wherein the first opening is opposite to a first end of the first stop portion and the second opening is opposite to a second end of the second stop portion relative to an axis of a shift shaft.

7. The shift fork according to claim 1, wherein the first shift jaw and the second shift jaw are spaced apart by an integral number of units of select travel of a shift shaft.

8. A gearbox, comprising:
a shift shaft; and
a shift fork, the shift fork comprising:
a first shift jaw;
a first shifting recess comprising a first stop portion for blocking a first movement of the first shift jaw in a first direction;
a second shift jaw; and
a second shifting recess comprising a second stop portion for blocking a second movement of the second shift jaw in a second direction,
wherein the first movement of the first shift jaw in the first direction along a direction of movement of the shift fork engages a reverse gearwheel of a reverse gear and the second movement of the second shift jaw in an opposite direction that is opposite to the first direction engages a forward gearwheel of a forward gear.

9. The gearbox according to claim 8, wherein the forward gearwheel of the forward gear is a gearwheel of a highest gear of the gearbox.

10. The gearbox according to claim 8, wherein the first shift jaw is situated above an axis of a linear ball bearing of the shift fork and the second shift jaw is situated below the axis of the linear ball bearing.

11. The gearbox according to claim 8,
wherein the shift shaft comprises a shift finger and a first hollow profile comprises a first opening for engagement with the shift finger and a second hollow profile comprises a second opening for engagement with the shift finger, and
wherein a third movement of the shift shaft by a multiple of a selection step moves the shift finger from the first opening into the second opening.

12. The gearbox according to claim 8, wherein the reverse gear and a highest gear are selectable by engagement of a shift finger with the shift fork and the reverse gear and the highest gear are positioned on different shift gates.

13. The gearbox according to claim 12, wherein the highest gear is an odd gear.

14. A power train assembly for a vehicle, comprising:
an input shaft;
an output shaft;
a gearbox between the input shaft and the output shaft; and
a shift fork for the gearbox, the shift fork comprising:
a first shift jaw;
a first shifting recess comprising a first stop portion for blocking a first movement of the first shift jaw in a first direction;
a second shift jaw; and
a second shifting recess comprising a second stop portion for blocking a second movement of the second shift jaw in a second direction.

15. The power train assembly according to claim 14, further comprising at least one driven wheel connected with the output shaft.

16. The power train assembly according to claim 14, wherein the first stop portion and the second stop portion are formed as circular sections.

17. The power train assembly according to claim 14, further comprising:
a first opening for engagement with a shift finger; and
a second opening for engagement with the shift finger.

18. The power train assembly according to claim 17, wherein the first opening and the second opening are arranged along an axis that is substantially perpendicular to a third direction of movement of the shift fork.

19. The power train assembly according to claim 17, wherein the first opening is adjacent to the first stop portion and the second opening is adjacent to the second stop portion.

20. The power train assembly according to claim 17, wherein the first opening is opposite to a first end of the first stop portion and the second opening is opposite to a second end of the second stop portion relative to an axis of a shift shaft.
